(19) United States
(12) Patent Application Publication
(10) Pub. No.: US 2016/0084947 A1
(43) Pub. Date: Mar. 24, 2016

(54) SONAR METHOD AND APPARATUS

(71) Applicant: KONGSBERG GEOACOUSTICS LTD., Norfolk (GB)

(72) Inventors: Peter Ian HOGARTH, Norfolk (GB); Duncan TAMSETT, Norfolk (GB)

(73) Assignee: KONGSBERG GEOACOUSTICS LTD., Norfolk (GB)

(21) Appl. No.: 14/785,041

(22) PCT Filed: Apr. 10, 2014
(86) PCT No.: PCT/EP2014/057311

§ 371 Date: Oct. 16, 2015

(30) Foreign Application Priority Data
Apr. 16, 2013 (GB) 1306863.0
Dec. 11, 2013 (GB) 1321876.3

(51) Int. Cl. G01S 7/52; G01S 15/89

(52) U.S. Cl. CPC G01S 7/52004; G01S 15/8902

(57) ABSTRACT

A method of calibrating a side scan sonar system by allowing the sonar transducer to roll with respect to the plane of a reference surface to be scanned; measuring the roll angle of the transducer during collection of backscattered sonar data; using backscattered sonar data from a range of transducer roll angles and the measured roll angle to decouple the operating characteristics of the transducer from the angular backscatter characteristics of the reference surface; thereby obtaining an estimate of the operating characteristics of the transducer.

### FIELD OF THE INVENTION

The invention relates to methods for determining the operating characteristics of sonar transducers, in particular the “beam function” of a sonar transponder. The invention also relates to apparatus and data processing systems configured to carry out the recited methods.

### BACKGROUND AND PRIOR ART

Side scan sonar is used in surveying underwater features, especially of the seabed and the bottom of other water-covered land, such as lakes. For simplicity, we refer to “seabed” in this specification, but this should be construed as to include other underwater features such as lake-beds. A side scan sonar emits lobe shaped pulses of sound to the sides of a sonar vehicle. Such a vehicle is usually towed behind a ship (or mounted on, or otherwise coupled to, the hull of a ship) along a series of tracks, in order to build up a picture (a sonar image) of the seabed. A sonic pulse spreading away from the sonar vehicle sweeps across the seabed. Signal back-scattered from the seabed is recorded by the sonar system as traces. The contiguous display of traces in which slant range is converted to horizontal range, represents an image of the seabed in top view, similar to an air photograph (vertical) over land.

Images of signal back-scattered from the seabed are a tapestry of image textures displaying characteristics of seabed materials. The effect of seabed material on raw back-scattered signal is however confounded by four other effects due to: 1. Geometrical spreading; 2. Absorption by travel through water; 3. The beam function—the intensity response for the transmitting-receiving transducer arrays verses inclination angle. 4. Seabed scatter functions—functions of seabed back-scattering intensity verses inclination angle.

If an image is corrected for these effects, image texture becomes a function of seabed material alone. Alternatives to correcting for these effects are: to apply an automatic gain control in hardware when data are acquired; or to apply an amplitude equalisation function in software. These lead to a measure of central tendency in intensity within a travelling window over an image being constant. Such images tend to be superficially more attractive than raw sonar images because there is no effect of geometrical spreading, absorption, beam or scatter function on signal amplitude, and the reduced dynamic range suppresses display saturation. However, whilst some seabed image textures such as rippled ones are readily recognisable to a great extent independently of signal amplitude, a wide range of seabed image textures without distinguishing bed forms, from silt to coarse gravel, are recognisable principally on the basis of signal amplitude, and texture mapping by human or machine attempted on the basis of amplitude independent features is difficult.

In order to make use of image amplitude as the primary seabed material discriminant, it is necessary to correct for the effects of geometrical spreading and absorption, and also for the effects of the beam and scatter functions (trace normalisation). In rendering image amplitude a function of sea-bed material alone (i.e. recovering true amplitude), trace normalisation considerably enhances the interpretability of sonar records for both human and machine.

The geometrical spreading and absorption functions are travel time dependent and may readily be compensated for by applying time varying gain (TVG) functions in hardware during acquisition before a trace is recorded. The accepted/preferred correct geometrical spreading correction for sonar images of the seabed is +30 log(R) dB, where R is the range or one-way travel distance. In addition a correction for absorption having the form +A.R dB should be applied (where A is the absorption coefficient in dB/m, which is a frequency dependent). If an inappropriate TVG has been applied, inclination angle dependent corrections subsequently applied in software will work inadequately. Where inappropriate TVG functions have been applied in hardware during acquisition, adjustments in software to the TVG should be made before data proceed to other processes.

Corrections for beam and scatter functions being functions of sonic ray inclination angle rather than travel time are more difficult to make than corrections that are functions of time. Hughes-Clarke, Danforth and Valentine (1997) and Hughes-Clarke (2004) extracted angular functions that are composites of beam and scatter functions. However, if the beam function could be determined independently in some way, it would be possible to decouple the effects of beam and scatter functions. The primary object amongst the objects of the invention is to provide such a method.

The beam function represents the signature of a side scan sonar system and in that respect is of interest in its own right. It also provides a foundation from which seabed back scatter functions may in turn be determined which are of geo-physical interest. Finally once a sonar's beam function and a seabed's scatter function are determined, trace normalisation may be applied to raw side scan sonar images to generate trace normalised images for interpretation by a geo-scientist.

An advantage of applying beam and scatter function corrections separately in trace normalisation is that the effect of vehicle roll can be accounted for when applying a correction for the beam function, and the effect of seabed slope can be accounted for when applying a scatter function correction, and an attempt can be made to apply different scatter functions for disparate seabeds. Trace normalisation, like amplitude equalisation, also leads to the benefit of a much reduced dynamic range.

### SUMMARY OF THE INVENTION

Accordingly, the invention provides a method of calibrating a side scan sonar system, said system comprising a sonar transducer, said method comprising the steps of: allowing the sonar transducer to roll with respect to the plane of a reference surface to be scanned; measuring the roll angle of the transducer during collection of backscattered sonar data from the surface to be scanned; using backscattered sonar data from a range of transducer roll angles and the measured roll angle to decouple the operating characteristics of the transducer from the angular backscatter characteristics of the reference surface; thereby obtaining an estimate of the operating characteristics of the transducer.

In this way, the rolling of the transducer causes sonic rays emitted by the transducer on any particular beam angle to be backscattered at different backscattering angles from the surface to be scanned (e.g. the seabed) thereby allowing the effects of backscatter angle and transducer beam function to be decoupled. Such effects are decoupled, because the methodology allows both the seabed scatter function and the transducer beam function to be independently determined (or at least estimated) thereby providing a means to calibrate the sonar system.

An important step in the methodology disclosed herein is allowing, or causing, a sonar transducer to roll with respect to the plane of a reference surface to be scanned. This rolling relationship, between the transducer and the reference surface (usually a seabed), allows a sonic ray emitted (and received) at a particular beam angle of the transducer to interrogate (i.e. to be backscattered from) the reference surface over a range of incident (i.e. backscatter) angles. There are a number of ways in which this may be achieved: In a first example, the transducer(s) may be attached to a survey ship, and the rolling of the ship on the sea surface produces the angular sweep of the sonic rays across the seabed surface. In a second example, the transducer(s) may be mounted on an actuator to cause rotation of the transducer(s) through a range of angles relative to the seabed, again thereby producing the required angular sweep of the sonic rays. In a third example, a transducer may be tracked across a portion of undulating seabed, thereby creating the required angular sweep. The availability of such a seabed surface is, in practice, probably unlikely on any particular survey site, and so in a fourth example, a transducer may be tracked across a portion of sloping seabed (i.e. sloping with respect to a notional flat sea surface) in such a way that the angle at which a sonic ray related to any particular beam angle of the transducer is incident with the seabed sweeps across a range of backscatter angles as the transducer moves along the survey track. This may be achieved by e.g. tracking the survey vessel on a curved path across a region of seabed comprising effectively an inclined plane. Changing the orientation of the survey path in this way thereby also achieves the requirement of sweeping a sonic ray associated with any particular beam angle across a range of backscatter angles. If the survey track is a closed loop, then the angular sweep becomes effectively periodic.

In particularly preferred embodiments of such a system, the transducer is tracked across a substantially straight path, and the transducer roll (relative to the reference seabed surface) is achieved by either the rolling of the ship as described in the first example above, or by rolling actuation of the transducer, as described in the second example above.

Preferably, the method comprises the steps of calculating a plurality of beam sub-functions corresponding to the relative angular transducer response over an angular range encompassed by the range of measured roll angles, said sub-functions together comprising an overlapping set of functions spanning the angular operating field of the transducer; normalising the sub-functions with respect to each other by minimisation of the overlapping regions; combining said normalised sub-functions form a single composite beam function for the transducer.

More preferably, the method comprising the steps of: using the composite beam function to estimate the backscatter characteristics of the reference surface by use of the collected backscatter data and the measured roll angle; using said estimated backscatter characteristics to determine an improved beam function from collected backscatter data and the measured roll angle.

In any such method, it is preferred that said side scan sonar system comprises a plurality of transducers, and the method further comprises the steps of: using the estimated beam function for each transducer to determine a common estimate of backscatter characteristics of the reference surface; and using said common estimate of backscatter characteristics to determine a further improved beam function for each transducer.

In a further embodiment, the invention also provides a calibrating a side scan sonar system, said system comprising a sonar transducer, said method comprising the steps of: allowing the sonar transducer to roll with respect to the plane of a reference surface to be scanned; measuring the roll angle of the transducer during collection of backscattered sonar data from the surface to be scanned; using backscattered sonar data from a range of transducer roll angles and the measured roll angle to decouple the operating characteristics of the transducer from the angular backscatter characteristics of the reference surface; thereby obtaining an estimate of the operating characteristics of the transducer, said method comprising the steps of: calculating a plurality of seabed scatter sub-functions, each corresponding to the intensity of seabed backscatter over an angular range encompassed by the range of measured roll angles, said sub-functions together comprising an overlapping set of functions spanning the angular range of inclination angles represented in the data; normalising the seabed scatter sub-functions with respect to each other by minimisation of differences between overlapping regions; combining said normalised seabed scatter sub-functions to form a single composite scatter function; using said composite scatter function to derive a beam function from the backscattered sonar data.

Preferably, and wherein said side scan sonar system comprises a plurality of transducers, the method further comprises the steps of: using the composite scatter function from each of said transducers to determine a single seabed scatter function; and using this single seabed scatter function to derive a beam function for each transducer from the backscattered sonar data.

Also in any method, it is preferred that bathymetry data is further used to correct for the slope of the reference surface.

The scope of the invention also includes a side scan sonar system configured to incorporate a calibration method described herein.

The scope of the invention also includes a data processing system, for processing side scan sonar data, configured to incorporate a calibration method described herein.

The scope of the invention also includes a method of calibrating a side scan sonar system substantially as described herein, with reference to and as illustrated by any appropriate combination of the accompanying drawings.

The scope of the invention also includes a side scan sonar system substantially as described herein, with reference to and as illustrated by any appropriate combination of the accompanying drawings.

The scope of the invention also includes a data processing system, for processing side scan sonar data, substantially as described herein, with reference to and as illustrated by any appropriate combination of the accompanying drawings.

Sonic rays emitted by the or each transducer, and received as backscattered signals, are backscattered from different portions of the seabed (or other such surface to be interrogated) as the reference plane of the transducer rolls with respect to the plane of the seabed. i.e. the sonic rays transmitted and received at any particular beam angle of the transducer(s) will be subject to backscatter at a range of backscatter angles as the transducer reference plane rolls, and sweeps the sonic ray (or pulses thereof) across a path perpendicular to the survey line as the transducer rolls. The consequence of this is that by exploiting the effect of roll, the effect of beam function and seabed backscatter function may be decoupled, allowing each of them to be estimated independently. This realisation underpins the theoretical basis of the invention.

### BRIEF DESCRIPTION OF THE FIGURES

The invention will be described with reference to the accompanying drawings, in which:

FIG. 1A illustrates a typical sonar transducer beam function and FIG. 1B a typical seabed scatter function, in radial form;

FIG. 2 illustrates the geometrical relationships between transducer and seabed for various combinations of roll and seabed slope;

FIG. 3 is a 2-dimensional plot of uncorrected amplitude signals;

FIG. 4 is a trace-normalised plot of amplitude signals;

FIG. 5 illustrates calculated beam sub-functions;

FIG. 6 illustrates calculated composite beam functions;

FIG. 7 illustrates calculated master beam functions; and

FIG. 8 illustrates a calculated seabed scatter function;

### DESCRIPTION OF PREFERRED EMBODIMENTS

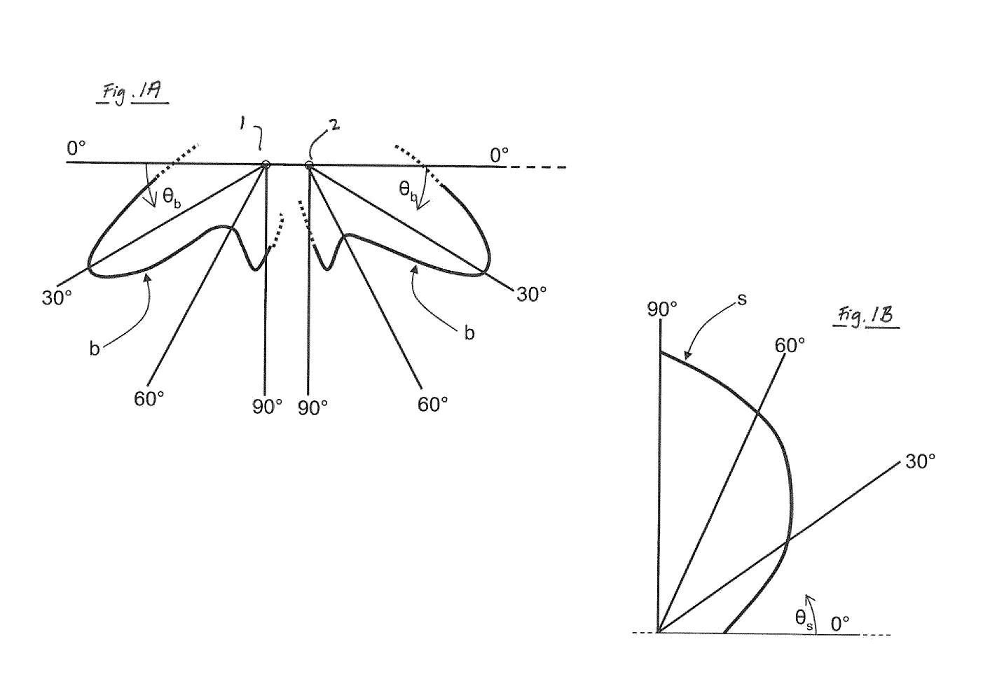

A typical beam function for a pair of sonar transducers 1, 2 is illustrated in FIG. 1A. These radial (polar) plots illustrate a typical response pattern for a transducer showing the response b as a function of the angle θₕ away from a notional horizontal reference orientation of the transducer. The response, b, is a combination of intensity of a sound wave produced by the transducer as a function of angle, θₕ, and the sensitivity of the device to measure the intensity of a back-scattered wave at that angle. For transducers used in side scan sonar, the relevant angles are usually between θₕ=0° and θₕ=90° (with the range extended by −+roll ° in the presence of sonar vehicle roll), corresponding to horizontally transmitted sound rays and to sound rays transmitted vertically towards the seabed. When the sonar vehicle rolls, the notional horizontal reference orientation of the transducer rotates with the sonar.

A typical seabed back scatter function, s(θₛ), is illustrated, again as a radial (polar) plot, in FIG. 1B. θₛ is the angle between the sonar ray and the plane in which the seabed lies at the point of incidence. A sound ray incident on the seabed at an angle θₛ backscatters in the reverse direction along the same line with an intensity function, s, having the form shown. This is a function describing the behaviour of the seabed, and is a single function (unlike the beam function which has a separate function for each transducer, e.g. port and starboard). If the seabed is sloping, the seabed reference rotates with the seabed.

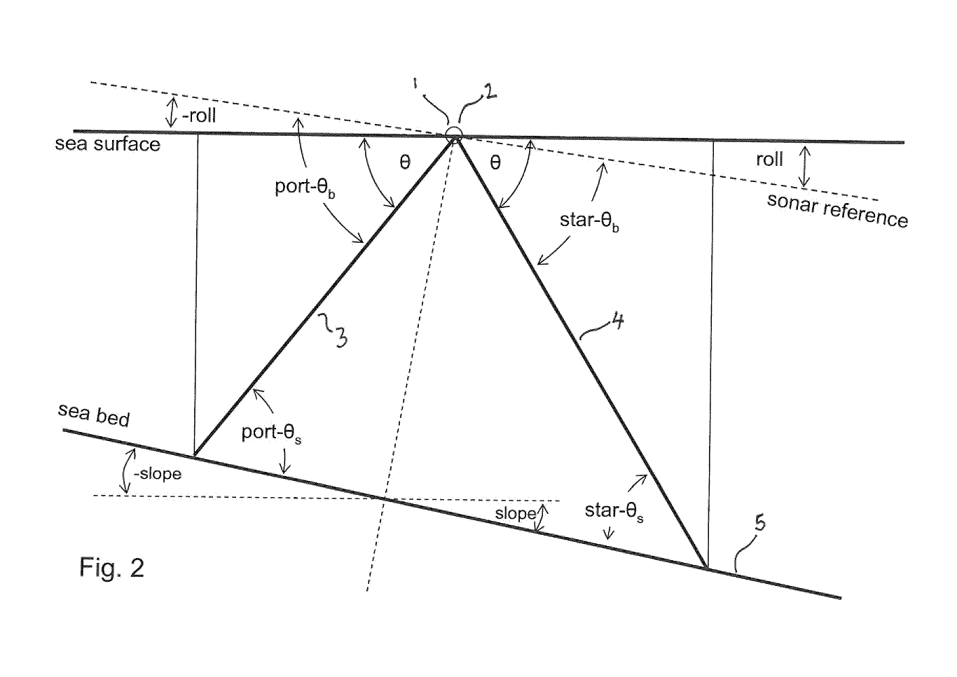

FIG. 2 illustrates the various frames of reference used to describe the methods described herein. The figure illustrates two sonic rays 3, 4 emitted from respective port (left) and starboard (right) transducers 1,2, said transducers shown here in juxtaposition, for clarity. These sonic rays 3, 4 illustrate the passage of sound emitted from the transducers 1,2 and returning along the same path following backscattering from the seabed 5. The angles θₛ, θₕ refer to the backscatter angle (i.e. the angle between the direction of travel of the backscattered sonic ray and the seabed) and the beam angle (i.e. the angle between the backscattered sonic ray and the reference plane of the sonar transducer) respectively. The angles in FIG. 2 are preceded by the prefixes port- and star- to represent the corresponding angles for a port and starboard transducer respectively, for a two-transducer system.

Characterisation of the roll of the transducers 1,2 is given by the angles roll and −roll as indicated. The slope of the seabed with reference to a notionally flat sea surface is given by the angle slope and −slope for the sonic rays 4 and 3 respectively.

Sonar data are collected from a side scan sonar system, typically having two transducers, one generally collecting data from the port side of a ship and the other collecting data from the starboard side of the ship. However, the method is generally applicable to systems that might only have a single transducer, or one that has more than two transducers. This latter situation might occur when multiple transducers are used, collecting data from essentially the same direction, but using a different sound frequency. For clarity, the method will be described for a two-transducer system, and the skilled addressee will readily be able to apply the method to systems having more transducers.

A sonar “ping” is transmitted from the transducer, and the backscattered sound is collected as an amplitude trace over time. We denote this trace as a′(i,j,t), being the received amplitude for trace i, transducer j at time t. The trace will typically be gated to remove signals received at times earlier than the time for sound to traverse the shortest distance between the sonar and the seabed. This cutoff time may be calculated by a knowledge of the speed of sound in water, and distance to the seabed. The distance to the sea bed will typically be known from separate bathymetry measurements, but in the absence of bathymetry, the sonar traces themselves may be used to provide an estimate of depth, allowing unwanted received signal (e.g. from passing fish shoals) to be readily gated from the signal.

The raw trace data will then typically be subjected to a time-varying gain, to correct for geometric signal spreading and attenuation. In some systems this correction will be made in the transducer hardware itself, or it may be applied during software post-processing. Such techniques are well-known in the art.

The amplitude vs. time signal may then be converted to amplitude vs. transducer angle, using a geometric relationship of distance to the seabed and distance travelled by the sound signal. Again, these techniques are well-known, and a series of traces denoted a_{abs}(θ,i,j) of corrected observed amplitude at angle θ for trace i, and transducer j.

These observed amplitude traces need to be corrected for the operating characteristics of the transducer, because the signal intensity of the sonic signal transmitted from the transducer will vary with angular position, and the sensitivity of transducer to detecting the returning sonic signal will also vary with angular position. This operating characteristic is usually referred to as a beam function, and it is a prime object of the present invention to provide a method for estimating the beam function for the transducers, i.e. effectively calibrating them.

The sonar Beam function and a seabed Scatter function are used in Normalisation of the traces in accordance with:

$${a}_{normal} ( θ ) = \frac{{a}_{obs} ( θ )}{{b}_{master} ( θ - roll ) \frac{s ( θ - slope )}{s ( {θ}_{m} )}} \qquad [ Eq . 1 ]$$

### Where:

θ (is the) inclination angle of a sonic ray from the sonar to the seabed measured +ve downwards from horizontal;
aₙₒᵣₘₐₗ normalised sonar trace amplitude function;
a_{obs} raw sonar trace amplitude function corrected for geometrical spreading and absorption;
bₘₐₛₜₑᵣ port or starboard sonar beam function;
s seabed backscatter function;
roll roll angle of the sonar vehicle;
slope angle from the horizontal of the seabed where a ray intersects the seabed.
θₘ the ‘reference’ angle (a constant e.g. 30°).

In a two-channel system, for the starboard channel, roll and slope are typically designated as being +ve clockwise with respect to, and in the plane perpendicular to, the direction of the sonar. For a port channel they are +ve anti-clockwise. This is the convention used herein, but the skilled address will readily be able to adapt the method should a different convention be employed.

The so called reference angle is chosen from a part of back-scatter functions where the response as a function of angle is relatively flat. A reference inclination angle of 30° is a good choice. The division of each coefficient in the scatter function in the above equation by the coefficient at θₘ has the effect of normalising the scatter function such that its response at θₘ is unity (0 dB). The beam function is normalised in this way already (for either the port or starboard channel) when it is computed.

a_{obs} and aₙₒᵣₘₐₗ are usually displayed as functions of time, t, but each datum is also associated with an angle, θ. As discussed above, the trace normalisation equation is applied to the observed trace, a_{obs}(t), at every time index, for t>=2d/v (where d is the distance from the sonar to the seabed and v is the velocity of sound in water), to generate the normalised trace, aₙₒᵣₘₐₗ(t), whilst avoiding the confounding effects of sound waves reflected or back-scattered from sources closer than the seabed.

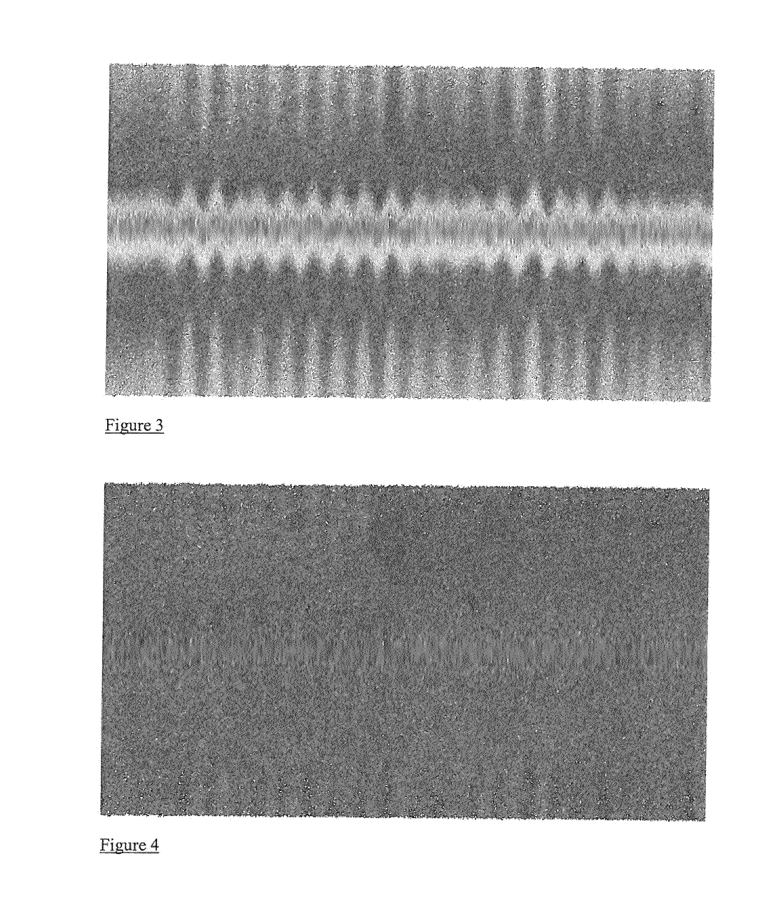

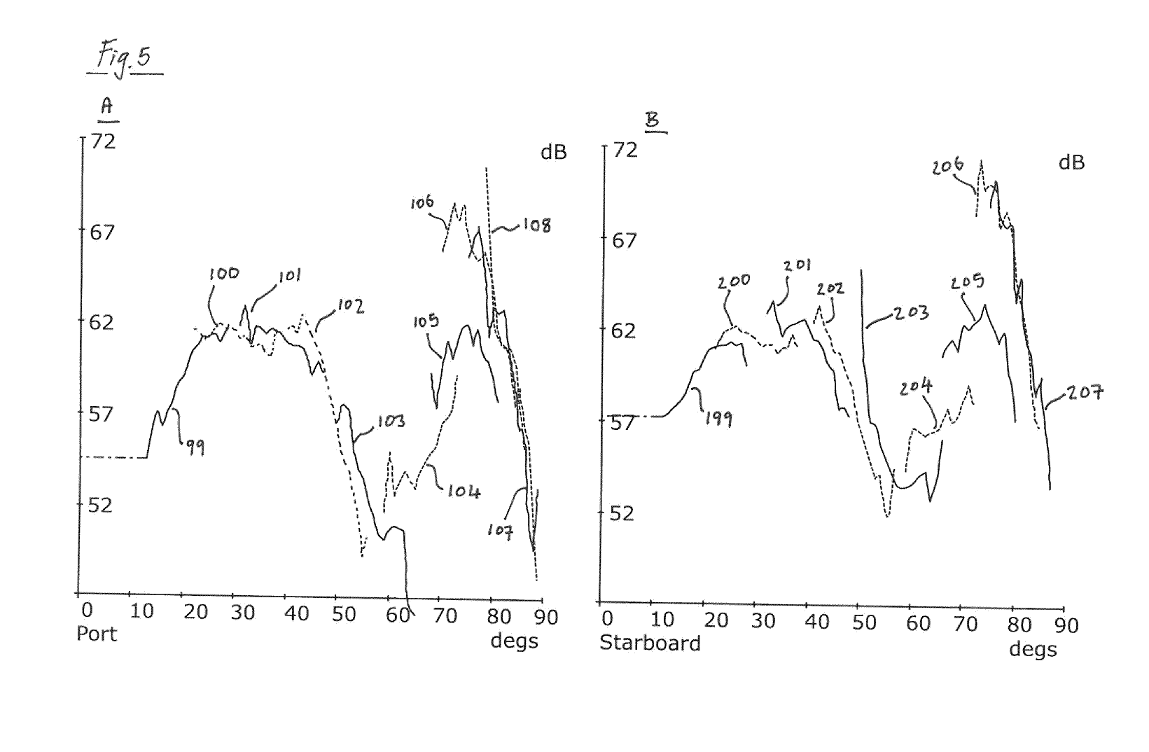

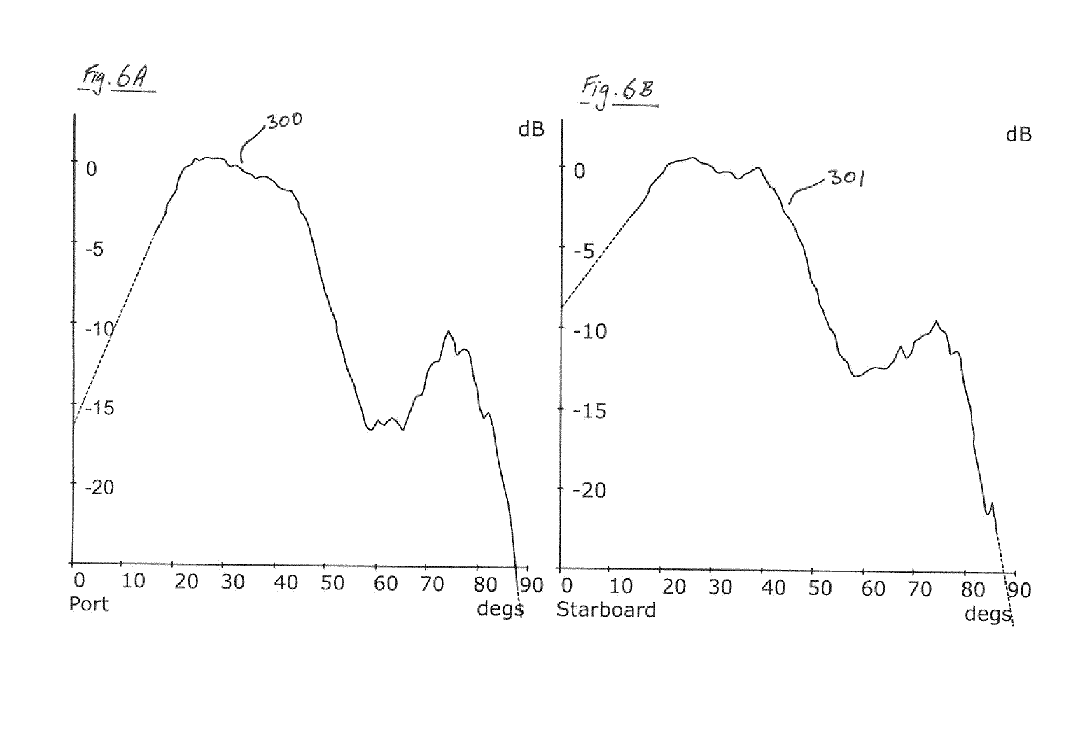

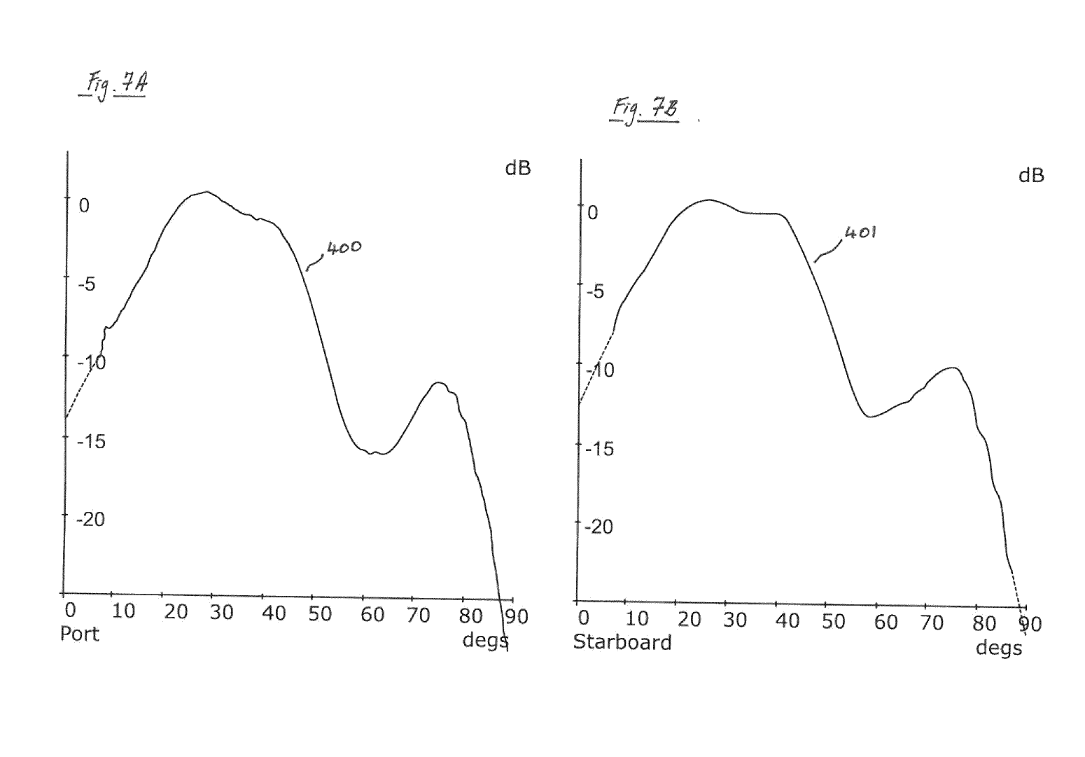

By way of illustration FIG. 3 shows a side scan sonar image (i.e. received amplitude data) that has been slant range corrected (i.e. the received angle from the transducers has been converted to horizontal displacement from the centre-line of the survey), and also corrected for geometrical spreading and signal attenuation. The image data are not, however, trace normalised and are therefore affected by sonar beam function and seabed scatter function. They are also particularly affected by roll, as can be seen in the oscillating nature of the signal across the image.

Illustrating the effect of Trace Normalisation, FIG. 4 shows the same data that have been trace normalised. It can be seen that most of the effects of the sonar's beam function, the seabed scatter function as well as the effects of roll have been eliminated from the image, and that the image (of a relatively homogeneous area of seabed) is very uniform, now being a strong function of essentially a single seabed material.

To be able to compute Trace Normalised traces, the Beam function for the sonar must have been determined in some way, and an appropriate seabed backscatter function (scatter function) must also have been determined. Two related approaches to calculation of beam function are described, allowing a side scan sonar system to be calibrated: In one approach, beam function is calculated via a route of determining a series of beam sub-functions, leading to calculation of an intermediate seabed scatter functions, and eventually a master beam function. Once the sonar beam function is determined, seabed scatter functions may subsequently be determined. In a second approach, a series of seabed scatter sub-functions are first calculated that may be reconciled to determine an intermediate master scatter function and then a master beam function. Both approaches are described below.

In order to carry out the determination of the beam function, the roll angle of the transducer, with respect to the sea bed is measured during the collection of each of the sonar traces. The period of roll of the transducers is typically much longer than the relevant timescale for transmission and backscatter of the sonic signal, and so a single measurement of roll for each sonar trace may usually be used. However, for more accurate determinations, e.g. if the roll frequency is high, or the seabed depth is great, roll angle may be measured as a function of time, with roll angle as a function of time being known for each trace.

Also, if multiple transducers are being used, it is usual that they are physically attached to the same sonar vehicle and thus have the same roll angle. In this case, a single roll sensor may be associated with the sonar vehicle, with the roll measurement data being common to all transducers. If the multiple transducers are not physically connected in this way, then separate roll sensors may be employed for each transducer.

Roll will typically be measured with respect to a datum plane, e.g. a notionally flat sea surface.

Method 1—Calibration via Beam Sub-Functions

In one embodiment of the invention, the first step in the process to determine an estimate of the beam function is to create a series of beam sub-functions, bᵣₒₗₗ_{_{—}}ₙ for each transducer, each over a restricted range of transducer angles from amplitude data for a number of traces collected from a rolling transducer. This may be calculated according to:

bᵣₒₗₗ_{_{—}}ₙ(θₙ−roll)=a_{obs}(θₙ) [Eq. 2]

A large number of data for each angular bin in the sub-beam functions are collected and averaged. Depending on the amount of roll encountered by the transducers, a number of overlapping such sub-beam functions may be calculated that together span the operating angular range of the transducers.

For example, for the first sub-beam function (n=0) a reference angle θ₀ is chosen to be equal to θₘ, typically around 30°, being the angle where the seabed scatter function has a relatively flat response. If the minimum and maximum roll angles available in the data are denoted as rollₘₐₓ and rollₘᵢₙ, then coefficients may be estimated for a beam function for the range (θₙ−rollₘₐₓ) to (θₙ−rollₘᵢₙ).

The process of calculating a beam sub-function is then repeated for n=1, 2, 3 etc and then n=−1, −2, −3 etc until the entire operating angular range of the transducer has been covered.

FIG. 5A illustrates a number of such sub-beam functions 99-108 representing sub-beam functions for n=−1 to n=8 for a port-side transducer using data collected from a two-transducer side-scan sonar system. Corresponding sub-beam functions 199-207 are shown in FIG. 5B for n=−1 to n=7 for a starboard-side transducer.

It can be seen that each sub-beam function overlaps with its neighbour, and that together, the sub-beam functions span essentially the whole of the operating angular range of each transducer.

It can also be seen that the sub-beam functions are displaced from each other, not forming a continuous beam function.

The next step in the process is therefore to align each sub-beam function with its angular neighbour (i.e. to align the sub-beam function for n=0 to the function for n=1, and so on). This may carried out by applying a factor to each function to minimize the difference between overlapping sub-beam function regions. When calculating the difference function to minimize in this process, a weighting factor may be applied to give greater weight to those portions of the sub-beam functions that were calculated using the most data.

Once this process has been carried out, composite beam functions are then created for each transducer. FIGS. 6A and 6B illustrate such composite beam functions for the port and starboard transducer data of FIG. 5, following this sub-beam function alignment process. The composite beam functions shown in these figures has been further normalised such that the response is shown as 0 dB at the reference angle θₘ for one of channels (in this example, the port channel).

These functions are the beam function but referred to as “seed” beam functions, for from it a more robust beam function may be computed. The port and starboard parts of the seed beam function are associated with their own seabeds.

Because the data for calibration are collected from essentially the same region of seabed, having approximately consistent features, the same scatter function should therefore apply to all (or each) of the beam functions determined. This is if data are collected in two directions along the same surveying track, as the port and starboard transducers will each gather data from an identical portion of the seabed, albeit at different times. For more robust determination of beam functions and seabed scatter functions, it is particularly preferred that such data are collected in two directions along the same surveying track.

To improve the estimated beam functions, a single intermediate master scatter function, Sᵢₙₜ₋ₘₐₛₜₑᵣ(θ), being the scattering characteristics of the seabed composited from the seabeds, used to compute both halves of the seed beam function, is calculated. This function may be calculated according to:

$${s}_{int - master} ( θ - slope ) = \frac{{a}_{obs} ( θ )}{{b}_{seed} ( θ - roll )} \qquad [ Eq . 3 ]$$

Where a_{obs}(θ) are the observed amplitude data, and b_{seed}(θ) is the “seed” beam function estimated in the previous method step. The slope term may be introduced for seabed measurements where the seabed is not flat, with slope being the seabed angle, if the seabed is not horizontal. This may be determined, for example, from bathymetry data.

A common seabed scatter function calculated from the data, is therefore used to determine the master beam function for each transducer according to:

$${b}_{master} ( θ - roll ) = \frac{{a}_{obs} ( θ )}{{s}_{int - master} ( θ - slope )} \qquad [ Eq . 4 ]$$

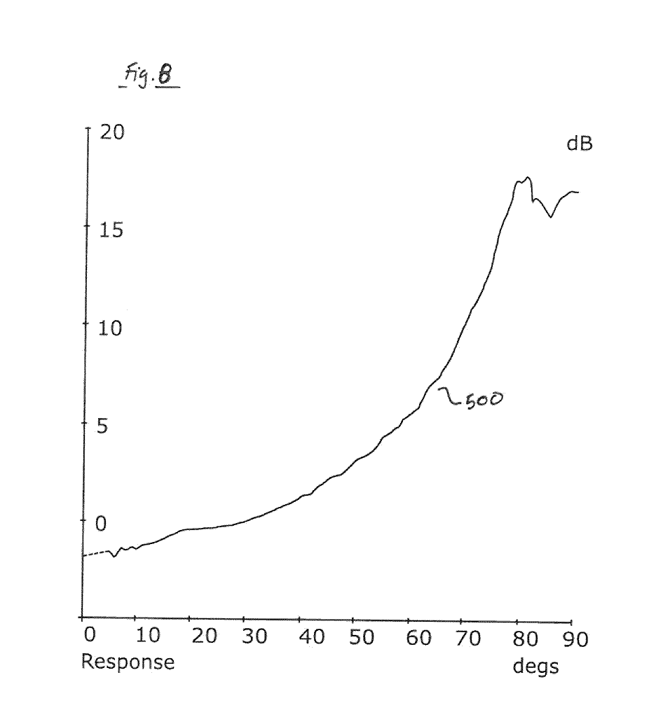

Each coefficient in the beam function that emerges is then divided by the coefficient for bₘₐₛₜₑᵣ(θₘ) for one of the transducers (e.g. the port one, for a two-transducer system) to normalise the beam function such that its response at θₘ (for the channel selected as the standard) is unity (as a factor) or 0 dB. Master beam functions, 400 and 401, calculated in this way are shown in FIGS. 7A and 7B for the port and starboard transducer data of FIG. 5.

The seabed back-scatter function 500 calculated from these data is illustrated in FIG. 8.

The process may be exemplified in more detail, and including practical computational guidance, as follows:

Whilst the equations above are cast in terms of continuous angular variables, it is of practical value that angular data is quantised for purpose of calculation. Values for the coefficients that emerge from the use of the equations that follow (2-5) are binned as functions of the angle θ (in say 1° bins), and arithmetic means computed for each bin from data in as many contiguous traces as practicable for good estimates of coefficients.

As discussed above, the first function that is required is an approximately correct beam function that we refer to as the ‘seed’ beam function. From this a more robustly determined ‘master’ beam function is computed. And from this in turn an appropriate number of seabed scatter functions may be determined. Sonar beam functions (transmit and receive) are sometimes measured in a laboratory, in which case such a function would serve as a suitable seed beam function. However, all too easily, not quite the correct measurement is made. The need for lab measurement can be circumvented by extracting a seed beam function from an image making use of accompanying sonar vehicle roll data, and this process is described next. A beam sub-function (a beam function over a restricted range of angles) may be extracted from an ensemble of contiguous traces in an image affected by a sufficient amount of sonar vehicle roll using:

bᵣₒₗₗ_{_{—}}ₙ(θₙ−roll)=a_{obs}(θₙ) 2

Multiple beam sub-functions extracted piecemeal may subsequently be reconciled to form a single composite beam function (encompassing all angles represented in the data).

For the first sub-beam function, n=0. θ₀ is the so called ‘reference angle’, θₘ. If the maximum and minimum roll in the ensemble of traces from which the beam function is extracted are rollₘₐₓ and rollₘᵢₙ respectively (e.g. ±5°), then coefficients may be estimated for a beam function for the range (θₘ−rollₘₐₓ) to (θₘ−rollₘₐₓ). However the number of data used to compute coefficients near the ends of this range will be small and therefore the range of roll values over which useful coefficients are extracted must be restricted to values yielding good estimates over the range.

The process is repeated subsequently for n=1, 2, 3 . . . , and then −1, −2, −3 . . . , in which θₙ is set to θ₀+n. (rollₘₐₓ−rollₘᵢₙ)/2. This yields a number of discrete beam sub-function which overlap at their ends (As already shown in FIG. 5). The sub-functions may be reconciled in the following way: Begin a composite function with the sub-function 0 (n=0). The composite function grows by progressively reconciling the other sub-functions to it by computing factors to map subsidiary sub-functions (n=1, 2, 3 . . . ; then −1, −2, −3 . . . ) onto the emerging composite function, from the values of coefficients where a sub-function overlaps the composite. The factors are appropriately weighted according to the number of data used to compute the values of coefficients. The factors are applied to coefficients such that the coefficients for sub-function |n| map onto the coefficients for sub-function |n|−1.

In this way a composite beam function emerges for the full range of angles encountered in the traces from which the beam function is extracted (FIG. 6).

A minimum amount of roll for this approach to beam function extraction to work adequately is; rollₘₐₓ and rollₘᵢₙ approximately ±(2 or 3)° (for 1° angular bins), although adequate results may be obtained for roll angles as little as ±1°. A correction for seabed slope cannot readily be made while applying this process and therefore the seabed should preferably be flat for the traces from which this function is extracted. This function then serves as the ‘seed’ beam function in the process of extracting a master beam function.

The Master Beam Function To extract a master beam function from an ensemble of contiguous traces with respect to a ‘seed’ beam function, a temporary intermediate-master scatter f function n is extracted first using:

sᵢₙₜ₋ₘₐₛₜₑᵣ(θ−slope)=a_{obs}(θ)/b_{seed}(θ−roll) [Eq. 3]

where:

sᵢₙₜ₋ₘₐₛₜₑᵣ (is the) intermediate-master scatter function;

b_{seed} seed beam function.

The seed beam function (e.g. FIG. 6) is the starting function and is an approximately correct beam function for the sonar system. It may be derived from measurement or calculation from theory, or by distillation from an image utilising roll information as just described.

The master beam function is then extracted with respect to the intermediate-master scatter function using:

bₘₐₛₜₑᵣ(θ−roll)=a_{obs}(θ)/sᵢₙₜ₋ₘₐₛₜₑᵣ(θ−slope) [Eq. 4]

Each coefficient in the beam function that emerges is now divided by the coefficient for bₘₐₛₜₑᵣ(θₘ) for one of the channels (e.g. the port one) to normalise the beam function such that its response at θₘ (for the channel opted as the standard) is unity (as a factor) or 0 dB (FIG. 7).

This is the master beam function. Note that the port and starboard halves of the master beam function are both extracted with respect to a common intermediate-master scatter function. In this way there is robustness in the internal consistency between the port and starboard beam function that is not present in the seed beam function derived directly from the roll data. This is one of the reasons the (seed) beam function derived from roll data should be subsequently superseded to generate the master beam function. Having computed the master beam function, the intermediate-master scatter function is now discarded. The master beam function is a property of the sonar (and also a function of sonar transmission frequency for a multi-frequency system, and possibly power output). Once a good master beam function has been computed it may be filed for re-use with other data acquired with the same system, and only replaced should an opportunity arise to compute a more accurate one with better (e.g. more) data.

FIG. 7 shows beam functions for the port and starboard channels. Note that these are different. Every sonar for a given manufactured system may look and be intended to be identical but in fact each (channel) is acoustically unique in a way that is statistically significant (the beam function constitutes a sonar's unique signature). There will invariably be readily visibly discernible deleterious effects if another sonar's beam function is inappropriately used.

Scatter Functions

Scatter functions (one or more) are extracted with respect to the master beam function using:

s(θ−slope)=a_{obs}(θ)/bₘₐₛₜₑᵣ(θ−roll) [Eq. 5]

The first scatter function would normally be computed from the same data used to compute the master beam function. (FIG. 8). The scatter function in FIG. 8 is shown normalised with respect to its value at θₘ.

The traces selected for extracting a trace normalisation (TN) function should be for an area of seabed that is uniform; and ideally for extracting the master beam function (and the first scatter function) the seabed should be the most common for the survey area.

FIGS. 7 and 8 illustrate a set of TN functions for a single frequency/monochrome sonar. (Multiple frequency data require the computation of a similar TN function set for each frequency). Coefficients are shown as dB rather than as amplitude factors (Coef_{dB}=20*log 10(factor)).

The effect of applying trace normalisation illustrated in FIGS. 3 and 4 shows that the effects of beam function and scatter function have been very satisfactorily compensated for, and quite impressively a strong effect of sonar vehicle roll in FIG. 3 prior to trace normalisation is all but absent in the trace normalised image in FIG. 4.

The scatter function is dependent on seabed material. A single scatter function generated for the most common seabed material in a survey area will often do an adequate job over the entire survey area. But disparate seabeds respond differently and have different scatter functions. The shape of the back-scatter function is affected by the strength of back-scattering by the seabed (the roughness of the seabed). If a survey area includes seabeds with large variations in back-scattering strength then additional scatter functions can be extracted to enable TN to perform more effectively.

Method 2—Calibration Via Seabed Scatter Sub-Functions

In this second, but related embodiment of the invention, an alternative route to computing a master beam function is via an intermediary seabed scatter function extracted directly from an ensemble of contiguous traces in an image affected by a sufficient amount of sonar vehicle roll, in a way similar to that described and illustrated already for directly extracting a seed beam function.

In this method, a series of scatter sub-functions (scatter function determined over a restricted range of inclination angles) may be extracted from an ensemble of contiguous traces in an image affected by roll using:

sᵣₒₗₗ_{_{—}}ₙ(θₙ−roll)=a_{obs}(θₙ+roll) [Eq. 6]

This process is analogous to the determination of beam sub-functions in Method 1, as described above, with reference to Equation 2.

The calculations may best be carried out by quantising the angles into a series of discrete “bins”, having an arbitrary bib-width, as described above. For every trace used to extract a scatter sub-function, the positions on the trace are found for which acoustic rays fall within the range of angles with the seabed, θₙ+roll±half bin width, taking seabed slope into account. The corresponding amplitude values, a_{obs}(θₙ+roll), are binned (i.e. assigned to a corresponding bin) for use in calculating the coefficient, sᵣₒₗₗ_{_{—}}ₙ(θₙ+roll). The effect of the beam function on the extracted back-scatter sub-function is a constant for the restricted range of angles represented by the amount of sonar vehicle roll.

Multiple scatter sub-functions may this be extracted piecemeal, in a way analogous to the extraction of multiple beam sub-functions as described above, and illustrated in

FIG. 5. These scatter sub-functions may then be subsequently reconciled to form port and starboard composite scatter functions (encompassing the full range of inclination angles represented in the data). Reconciliation may be carried out by considering the overlapping portions of adjacent scatter sub-functions, and scaling the sub-functions such that the difference between adjacent sub-functions is minimised in the overlapping portion. Again, the scaling may be weighted depending on the number of datapoints available for calculation. The details are analogous to those already described already for constructing a beam function according to Method 1. The separate port and starboard scatter functions that emerge are then combined (e.g. by averaging the two scatter functions) to form a single seabed scatter function.

This scatter function will have an arbitrary value at the reference angle. However, this does not matter because this function is to be regarded as an intermediate master scatter function from which a master beam function may be computed in the way described in a previous section (equation 4), thereby effecting calibration of the sonar system.

### REMARKS

A scatter function is dependent on seabed material. A single scatter function generated for the most common or the most median seabed material in a survey area will sometimes do an adequate job if used to correct data over the entire survey area. But disparate seabeds respond differently and can have very different scatter functions. The shape of the back-scatter function is affected by the strength of back-scattering by the seabed (the roughness of the seabed). If a survey area includes disparate seabeds with large variations in back-scattering strength then additional scatter functions can be extracted to enable TN to perform more effectively. If for a survey area more than one scatter function is extracted then a system may be configured to decide which scatter function to apply (or between which two scatter functions to interpolate). Another option is to continuously update an adapting scatter function computed from traces in the vicinity of the trace for which a correction for scatter function is being applied.

A scatter function constitutes a seabed's characteristics and a collection of scatter functions can provide a basis for seabed classification (similar to Hughes-Clarke, 1994). If multiple scatter functions are extracted to represent all seabed types in a survey area, a process can determine at each pixel the scatter function that most closely matches the seabed. In so doing, a seabed classification is effectively made.

If the extraction of scatter functions is supervised by a suitably experienced geoscientist, ideally with access to ground truth information, image seabed classification constitutes a geo-interpretation of the image, achieved as a by product of applying TN processes. The initial classification may be non-linear filtered to provide a smoothing effect on classification decisions that might in some places be noisy.

It has been assumed in the fore-going that a sonar trace is associated with a single value of sonar vehicle roll. This is typically a good approximation in short range surveying where the frequency of vehicle roll is much less than the trace or pulse repetition frequency. However where this condition is not met (e.g. for long range soundings), the analysis must be extended to consider roll as a function of time. For each trace, the transmit part of the beam function will be associated with a single value of roll, but the receive part will be associated with roll that varies with time.

A sonar beam function may be extracted from sonar image trace data and sonar vehicle roll data. Subsequently seabed back-scatter functions may be extracted for disparate seabeds from sonar trace data, with respect to the beam function. The Trace Normalisation process can then account for the effects of vehicle roll and seabed slope when correcting for sonar beam and seabed scatter functions. This yields a recovery of true signal amplitude (with respect to the reference angle) and image texture, representing seabed material across the full width of side scan sonar imagery, un-confounded by the effects of sonar beam (and roll) and seabed hack scatter functions (and seabed slope). As an alternative route to extracting a sonar beam function from sonar image data and sonar vehicle roll data; instead a seabed back-scatter function may be extracted from sonar image data and sonar vehicle roll data. This may then serve as an intermediary function from which a beam function is extracted from image trace data, with respect to the scatter function.

### REFERENCES

Chesterman, W. D., Clynick, P. R. and Stride, A. H., An acoustic aid to sea-bed survey, Acustica 8: 285-290, 1958.
Hughes Clarke, J. E., Toward remote seafloor classification using the angular response of acoustic backscattering: a case study from overlapping GLORIA data, IEEE Journal of Oceanic Engineering, 19, 112-127, 1994.
Hughes Clarke, J. E., Danforth, B. W., Valentine, P., Areal seabed classification using backscatter angular response at 95 kHz., NATO SACLANTCEN Conference Proceedings Series CP-45, High Frequency Acoustics in Shallow Water, Lerici, Italy, pp. 243-250, 1997.
Hughes Clarke, J. E., Seafloor characterization using keel-mounted sidescan: proper compensation for radiometric and geometric distortion, Canadian Hydrographic Conference, May, 2004.

1. A method of calibrating a side scan sonar system, said system comprising a sonar transducer, said method comprising the steps of:
allowing the sonar transducer to roll with respect to the plane of a reference surface to be scanned;
measuring the roll angle of the transducer during collection of backscattered sonar data from the surface to be scanned;
using backscattered sonar data from a range of transducer roll angles and the measured roll angle to decouple the operating characteristics of the transducer from the angular backscatter characteristics of the reference surface;
thereby obtaining an estimate of the operating characteristics of the transducer.

2. A method according to claim 1 comprising the steps of calculating a plurality of beam sub-functions corresponding to the relative angular transducer response over an angular range encompassed by the range of measured roll angles, said sub-functions together comprising an overlapping set of functions spanning the angular operating field of the transducer;
normalizing the sub-functions with respect to each other by minimization of the overlapping regions;
combining said normalized sub-functions to form a single composite beam function for the transducer.

3. A method according to claim 2 comprising the steps of:
using the composite beam function to estimate the backscatter characteristics of the reference surface by use of the collected backscatter data and the measured roll angle;
using said estimated backscatter characteristics to determine an improved beam function from collected backscatter data and the measured roll angle.

4. A method according to claim 1 wherein said side scan sonar system comprises a plurality of transducers, and the method further comprises the steps of:
using the estimated beam function for each transducer to determine a common estimate of backscatter characteristics of the reference surface; and
using said common estimate of backscatter characteristics to determine a further improved beam function for each transducer.

5. A method according to claim 1 comprising the steps of:
calculating a plurality of seabed scatter sub-functions, each corresponding to the intensity of seabed backscatter over an angular range encompassed by the range of measured roll angles, said sub-functions together comprising an overlapping set of functions spanning the angular range of inclination angles represented in the data;
normalizing the seabed scatter sub-functions with respect to each other by minimization of differences between overlapping regions;
combining said normalized seabed scatter sub-functions to form a single composite scatter function;
using said composite scatter function to derive a beam function from the backscattered sonar data.

6. A method according to claim 5 wherein said side scan sonar system comprises a plurality of transducers, and the method further comprises the steps of:
using the composite scatter function from each of said transducers to determine a single seabed scatter function; and
using this single seabed scatter function to derive a beam function for each transducer from the backscattered sonar data.

7. A method according to claim 1 wherein bathymetry data is further used to correct for the slope of the reference surface.

8. A side scan sonar system configured to incorporate a calibration method according to claim 1.

9. A data processing system, for processing side scan sonar data, configured to incorporate a calibration method according to claim 1.

10. A method of calibrating a side scan sonar system substantially as described herein, with reference to and as illustrated by any appropriate combination of the accompanying drawings.

11.-12. (canceled)
